(19) United States
(12) Patent Application Publication
(10) Pub. No.: US 2017/0297149 A1
(43) Pub. Date: Oct. 19, 2017

(54) CLADDING ALLOY POWDER AND METHOD FOR PRODUCING ENGINE VALVE USING THE SAME

(71) Applicant: TOYOTA JIDOSHA KABUSHIKI KAISHA, Toyota-shi (JP)

(72) Inventors: Nobuyuki SHINOHARA, Tajimi-shi (JP); Yuki KAMO, Okazaki-shi (JP)

(73) Assignee: TOYOTA JIDOSHA KABUSHIKI KAISHA, Toyota-shi (JP)

(21) Appl. No.: 15/471,144

(22) Filed: Mar. 28, 2017

(30) Foreign Application Priority Data
Apr. 13, 2016 (JP) 2016-080575

(51) Int. Cl. B23K 35/32; B23K 35/02; F01L 3/04; B23K 10/02; F01L 3/02; C22C 30/00; B23K 101/00

(52) U.S. Cl. CPC B23K 35/32; F01L 3/02; B23K 35/0244; C22C 30/00; F01L 3/04; B23K 10/027; B23K 2201/00; F01L 2101/00; F01L 2103/00

(57) ABSTRACT

Provided are a cladding alloy powder that can increase the wear resistance of a cladding alloy to be deposited and a counterpart member adapted to contact the cladding alloy, and a method for producing an engine valve using the cladding alloy powder. The cladding alloy powder includes 0.2 to 0.5 mass % C, 30 to 45 mass % Mo, 15 to 35 mass % Ni, 0.5 to 2.0 mass % Zr, and a balance including Co with unavoidable impurities. The method for producing an engine valve includes melting the cladding alloy powder, and cladding a valve face portion of an engine valve adapted to contact a valve seat with the melted cladding alloy powder.

### CLAIM OF PRIORITY

The present application claims priority from Japanese patent application JP 2016-080575 filed on Month Date, Year, the content of which is hereby incorporated by reference into this application.

### BACKGROUND

### Technical Field

The present disclosure relates to a cladding alloy powder for cladding the surface of a steel material, and a method for producing an engine valve using the cladding alloy powder.

### Background Art

Conventionally, devices that are used under a high-temperature environment, such as intake valves and exhaust valves of internal combustion engines, are formed using heat-resisting steel in order to have increased wear resistance and the like. In particular, valve face portions and the like of engine valves are required to have wear resistance, low agressivity against a counterpart member, heat resistance, and thermal impact resistance in a wide temperature range of from the room temperature to a high temperature.

However, heat-resisting steel that is commonly used as a valve material is not sufficient in such properties. Therefore, a cladding alloy powder with such properties is melted so as to clad (be deposited on) a valve face portion and thus provide the properties to the valve face portion. In particular, an engine that uses CNG as a fuel has low oxidation ability in a burning atmosphere. Therefore, a cladding alloy powder that has excellent oxidation ability, that is, a cladding alloy powder that can easily form an oxide film is used for such an engine.

For example, Patent Document 1 proposes a cladding alloy powder that contains 0.7 to 1.0 mass % C, 30 to 40 mass % Mo, 20 to 30 mass % Ni, 10 to 15 mass % Cr, and a balance including Co with unavoidable impurities.

When a cladding alloy is deposited using such a cladding alloy powder, which contains 0.7 to 1.0 mass % C with the previously indicated Mo and Ni contents, a Mo oxide film is formed on the surface of the deposited cladding alloy of the cladding alloy powder, and primary carbide crystals, which are a fracture origin, are not produced in the cladding alloy, while eutectic carbides of Mo are produced. This can improve the toughness and wear resistance of the cladding alloy than those of cladding alloys of the related art and improves the thermal impact resistance.

### RELATED ART DOCUMENTS

### Patent Documents

Patent Document 1: JP 2011-255417 A

### SUMMARY

As described above, when a steel material is cladded with the cladding alloy powder described in Patent Document 1, the wear resistance is surely improved than those of cladding alloys of the related art. However, even when such a cladding alloy powder is used, the formation of a Mo oxide film on the surface of a cladding alloy to be deposited is not sufficient during use. Further, under a corrosive environment, hard carbides of Mo may protrude from the surface of the deposited cladding alloy due to corrosion of the surface, and the surface of the cladding alloy may thus become rough.

Accordingly, there may be cases where sufficient adhesion resistance and wear resistance of the cladding alloy and a counterpart member, which slides on the cladding alloy, against each other cannot be provided by the oxide film, and in such cases, agressivity against the counterpart member may be increased due to the surface of the cladding alloy that has become rough due to corrosion.

The present disclosure has been made in view of the foregoing problems, and it is an object of the present disclosure to provide a cladding alloy powder that can increase the wear resistance of a cladding alloy to be deposited and a counterpart member, which contacts the cladding alloy, against each other, and a method for producing an engine valve using the cladding alloy powder.

In order to solve the aforementioned problems, the inventors have conducted concentrated studies and found that formation of a Mo oxide film on the surface of a cladding alloy to be deposited depends on the amount of Mo that is solid-dissolved in a Co base material. Further, it has been found that the aforementioned corrosion of the surface of the cladding alloy is generated on the Co base material around the Mo carbides formed in the cladding alloy. It has been considered that the Co base material around the corroded portion has a smaller amount of Mo solid-dissolved therein than that in the Co base material of the other portions, and that galvanic corrosion occurs between the Mo carbides and the portion of the Co base material with a small amount of Mo solid-dissolved therein. Accordingly, the inventors have determined that increasing the amount of Mo to be solid-dissolved in the cladded Co base material can promote the formation of a Mo oxide film and reduce corrosion of the Co base material around Mo carbides.

From the foregoing viewpoint, the inventors focused on Zr that is preferentially combined with C than is Mo as an element to be contained in a cladding alloy powder. Accordingly, it has been newly found that preferentially generating Zr carbides during cladding can allow a more amount of Mo to be solid-dissolved in a Co base material than in cladding alloy powders of the related art while suppressing the amount of Mo consumed as Mo carbides and thus maintaining the strength of the resulting cladding alloy.

The present disclosure has been made in view of such new finding. A cladding alloy powder in accordance with the present disclosure includes 0.2 to 0.5 mass % C; 30 to 45 mass % Mo; 15 to 35 mass % Ni; 0.5 to 2.0 mass % Zr; and a balance including Co with unavoidable impurities.

Further, a method for producing an engine valve in accordance with the present disclosure includes melting the aforementioned cladding alloy powder; and cladding a valve face portion of an engine valve adapted to contact a valve seat with the melted cladding alloy powder.

Using the cladding alloy powder of the present disclosure can increase the wear resistance of a cladding alloy to be deposited and can also decrease the agressivity against a counterpart member. In particular, when a valve face portion of an engine valve is cladded with the cladding alloy powder, the valve face portion that has the resulting cladding alloy deposited thereon can have increased wear resistance. Further, as the agressivity against a valve seat as a counterpart member can be reduced, the volume of wear of the valve seat can be reduced. The engine valve produced with the aforementioned production method is preferably used for an engine in which an alcohol fuel, LPG (Liquefied Petroleum Gas) or CNG (Compressed Natural Gas) is used as a fuel.

### BRIEF DESCRIPTION OF THE DRAWINGS

FIG. 1 is a schematic diagram illustrating the state of the surface of a cladding alloy deposited using a cladding alloy powder in accordance with an embodiment when the cladding alloy is placed under a corrosive environment.

FIG. 2 is a schematic conceptual diagram of a wear tester.

FIG. 3A is a photograph obtained by observing the structure of a cladding alloy of a test piece of Example 1 using an optical microscope.

FIG. 3B is a photograph obtained by observing the structure of a cladding alloy of a test piece of Comparative Example 6 using an optical microscope.

FIG. 4 is a graph showing the relationship between the oxidation start temperature and the wear volume ratio of each of Examples 1 to 9 and Comparative Examples 2, 4, 5, and 8.

FIG. 5 is a graph showing the relationship between the Zr content and the oxidation start temperature of each of Examples 1 to 3 and Comparative Examples 1, 2, and 9.

FIG. 6 is a graph showing the relationship between the Zr content and the generation rate of blowholes of each of Examples 1 to 9 and Comparative Examples 1 and 2.

FIG. 7A is a photograph obtained by observing the structure of a cladding alloy of a test piece of Example 1 after a corrosion test using a scanning electron microscope.

FIG. 7B is a photograph obtained by observing the structure of a cladding alloy of a test piece of Comparative Example 2 after a corrosion test using a scanning electron microscope.

### DETAILED DESCRIPTION

Hereinafter, embodiments of the present disclosure will be described in detail.

### 1. Regarding Cladding Alloy Powder

A cladding alloy powder in accordance with this embodiment is a cladding alloy powder for cladding the surface (valve face portion) of an engine valve (base material) made of a metal material described below. As used herein, the term “cladding alloy powder” is an aggregate of cladding alloy particles, and the cladding alloy particles contain elements (composition) described below.

The cladding alloy powder in accordance with this embodiment contains 0.2 to 0.5 mass % C, 30 to 45 mass % Mo, 15 to 35 mass % Ni, 0.5 to 2.0 mass % Zr, and a balance including Co with unavoidable impurities.

Such hard particles can be produced by preparing an alloy melt, which has been obtained by blending the aforementioned elements at the aforementioned percentages and atomizing the alloy melt. Alternatively, as another method, it is also possible to turn a solid body, which has been obtained by solidifying an alloy melt, into a powder through mechanical grinding. Examples of the atomization process include a gas atomization process and a water atomization process.

Herein, the aforementioned lower limit and upper limit of the composition of the cladding alloy powder can be changed as appropriate in accordance with the degree of importance of each property of a member to which the cladding alloy powder is applied, considering the reasons for limiting the composition described below, and further, the hardness, solid lubricity, adhesion, cost, or the like within the range.

1-1: 0.2 to 0.5 Mass % C

Of the composition of the cladding alloy powder, C is an element used to increase the hardness of a cladding alloy to be deposited by generating carbides with Mo and thus increase the wear resistance of the cladding alloy. When the cladding alloy powder contains 0.2 to 0.5 mass % C, it is possible to generate carbides with Mo while suppressing generation of primary carbide crystals, thereby increasing the wear resistance of the cladding alloy.

Herein, when the C content in the cladding alloy powder is less than 0.2 mass %, the amount of carbides of Mo generated in a cladding alloy to be deposited may not be sufficient, and the wear resistance of the cladding alloy may thus decrease. Meanwhile, when the C content is over 0.5 mass %, primary carbide crystals become likely to be generated in a cladding alloy to be deposited. Accordingly, the toughness, tensile strength, and elongation of the cladding alloy may decrease, and cracks may thus be generated in the cladding alloy (for example, see Comparative Example 7 described below). Preferably, the C content is 0.25 to 0.35 mass %.

1-2: 30 to 45 Mass % Mo

Of the composition of the cladding alloy powder, Mo is an element used to form a Mo oxide film for suppressing adhesion between a cladding alloy to be deposited and a counterpart member, which is adapted to contact the cladding alloy, and generate carbides of Mo while suppressing generation of primary carbide crystals, thereby improving the wear resistance of the cladding alloy.

When the cladding alloy powder contains 30 to 45 mass % Mo, it is possible to suppress generation of primary carbide crystals in a cladding alloy to be deposited, generate eutectic carbides, and thus increase the wear resistance of the cladding alloy. Further, when a member that has the cladding alloy formed thereon is used, it is possible to form a Mo oxide film described above as a protective film with excellent solid lubricity on the surface of the cladding alloy. Accordingly, it is possible to reduce adhesive wear against a counterpart member while reducing agressivity against the counterpart member.

Herein, when the Mo content in the cladding alloy powder is less than 30 mass %, not only is the amount of the generated carbides of Mo small, but also the oxidation start temperature of the cladding material is high (for example, see Comparative Example 4 described below). Accordingly, generation of a Mo oxide under a high-temperature use environment is suppressed, and the wear resistance of a cladding alloy to be deposited thus becomes low.

Meanwhile, when the Mo content is over 45 mass %, primary carbide crystals may be generated in a cladding alloy to be deposited, with the result that the toughness of the cladding alloy may decrease and cracks may thus be generated in the cladding alloy (for example, see Comparative Example 3 described below). Preferably, the Mo content is 35 to 45 mass %.

1-3: 15 to 35 Mass % Ni

Of the composition of the cladding alloy powder, Ni is an element used to suppress generation of primary carbide crystals in a cladding alloy to be deposited by increasing the amount of C to be solid-dissolved in the Co base material, and increase the toughness of the cladding alloy. When the cladding alloy powder contains 15 to 35 mass % Ni, it is possible to suppress generation of primary carbide crystals and increase the toughness of a cladding alloy to be deposited.

Herein, when the Ni content in the cladding alloy powder is less than 15 mass %, primary carbide crystals may be generated in a cladding alloy to be deposited, with the result that the toughness of the cladding alloy may decrease and cracks may thus be generated in the cladding alloy (for example, see Comparative Example 6 described below). Meanwhile, when the Ni content is over 35 mass %, the hardness of a cladding alloy to be deposited may decrease, and the wear resistance may thus decrease (for example, see Comparative Example 5 described below). Preferably, the Ni content is 15 to 25 mass %.

1-4: 0.5 to 2.0 Mass % Zr

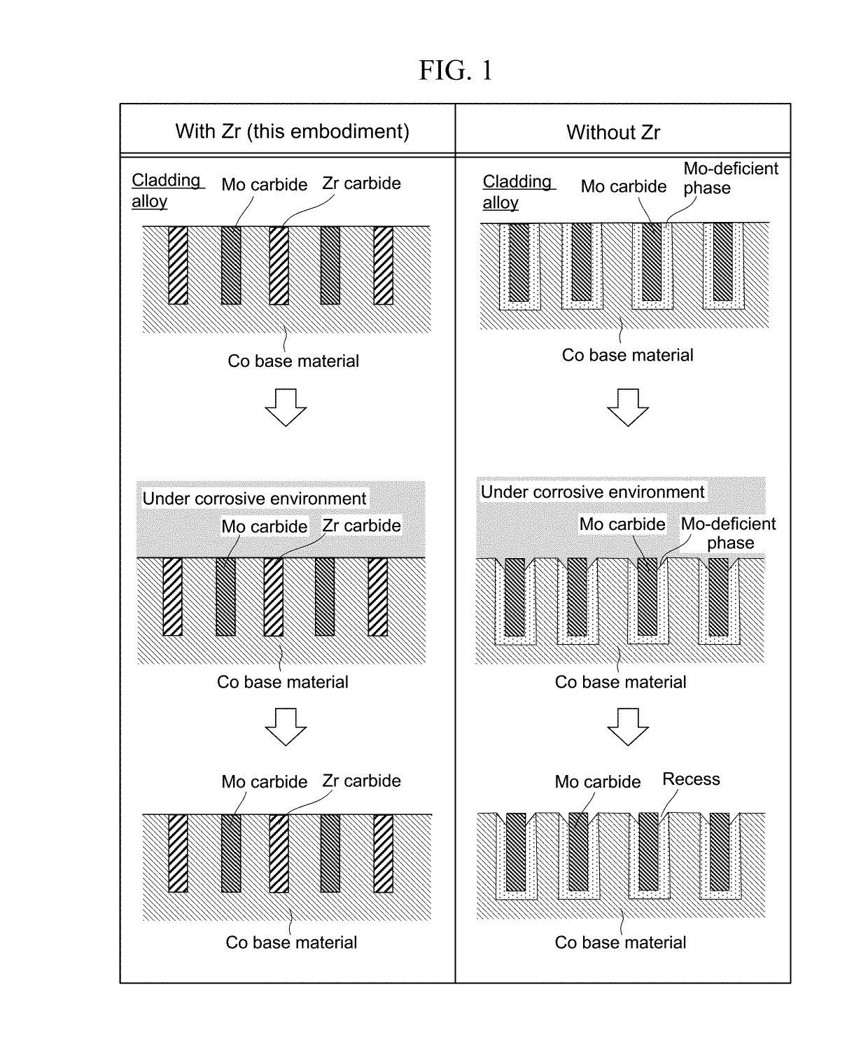

Of the composition of the cladding alloy powder, Zr is an element used to increase the oxidation properties of a cladding alloy to be deposited and thus increase the wear resistance. When the cladding alloy powder contains 0.5 to 2.0 mass % Zr, the oxidation start temperature of the cladding alloy powder as well as the deposited cladding alloy can be lowered (see FIG. 5 described below). Accordingly, a more continuous Mo oxide film can be formed on the surface of the cladding alloy, and adhesive wear against a counterpart member can thus be reduced. Further, the possibility that the surface of the deposited cladding alloy may become rough due to corrosion of the surface of the cladding alloy can be prevented. Preferably, the Zr content is 1.0 to 2.0 mass %. Such points are described in detail below with reference to FIG. 1.

FIG. 1 is a schematic diagram illustrating the state of the surface of a cladding alloy deposited using the cladding alloy powder in accordance with this embodiment when the cladding alloy is placed under a corrosive environment. As shown in the right column of FIG. 1, when the cladding alloy powder does not contain Zr, a Mo-deficient phase that contains a less amount of Mo solid-dissolved therein is formed in the Co base material around a Mo carbide generated in the cladding alloy in comparison with the amount of Mo solid-dissolved in the Co base material in the other portions (see the upper portion of the right column).

When the cladding alloy is exposed under a corrosive environment such as an environment in which the cladding alloy contacts corrosive water, galvanic corrosion occurs between the Mo carbide and the Mo-deficient phase, so that the Mo-deficient phase with low corrosion resistance becomes corroded (see the middle portion of the right column). Consequently, a recess is formed around the Mo carbide, and the Mo carbide, which is hard, protrudes from the surface, and thus, the surface of the cladding alloy becomes rough (see the lower portion of the right column).

However, as the cladding alloy powder in this embodiment contains Zr that has a higher tendency to generate carbides than does Mo, carbides of Zr are generated preferentially than carbides of Mo during cladding. Accordingly, Mo to be consumed as Mo carbides can be allowed to remain in the state of being solid-dissolved in the Co base material. Consequently, as shown in the left column of FIG. 1, it is possible to suppress formation of Mo-deficient phases around Mo carbides in the cladding alloy (see the upper portion of the left column), and thus suppress galvanic corrosion resulting from Mo-deficient phases (see the middle portion of the left column). Accordingly, the surface of the cladding alloy deposited in this embodiment can be maintained smooth even when it is exposed under a corrosive environment in comparison with a cladding alloy without Zr (see the lower portion of the left column). Thus, agressivity against a counterpart member can be reduced during sliding (during use).

Further, as carbides of Zr are generated preferentially than carbides of Mo during cladding as described above, the amount of Mo that is solid-dissolved in the Co base material is increased in comparison with a case where Zr is not contained. Thus, in comparison with a case where Zr is not contained, the oxidation start temperature of a cladding alloy to be deposited becomes lower, and thus, a Mo oxide film can be easily formed with Mo in the Co base material during sliding (during use). Consequently, adhesive wear between the cladding alloy and a counterpart member, which slides on the surface of the cladding alloy, can be reduced.

Meanwhile, when the base material to be cladded contains N solid-dissolved therein, part of Zr other than those, which are combined with C, are combined with N during cladding. Thus, N in the base material becomes a nitrogen gas. As such a nitrogen gas is unlikely to be contained in the cladding alloy in the molten state, it is possible to suppress formation of blowholes (gas defects) in the cladding alloy.

Herein, when the Zr content in the cladding alloy powder is less than 0.5 mass %, a Mo oxide film may not be formed sufficiently, so that the surface of a cladding alloy to be deposited may become corroded under a corrosive environment, and thus may become rough (for example, see Comparative Example 2 described below). Further, as described below, when the base material to be cladded contains N solid-dissolved therein, the solid-dissolved N becomes a nitrogen gas, and thus forms blowholes in the cladding alloy. Meanwhile, even when the Zr content in the cladding alloy powder is over 2.0 mass %, advantageous effects more than those described above cannot be expected (for example, see Comparative Example 1 below).

### 2. Method for Producing Engine Valve

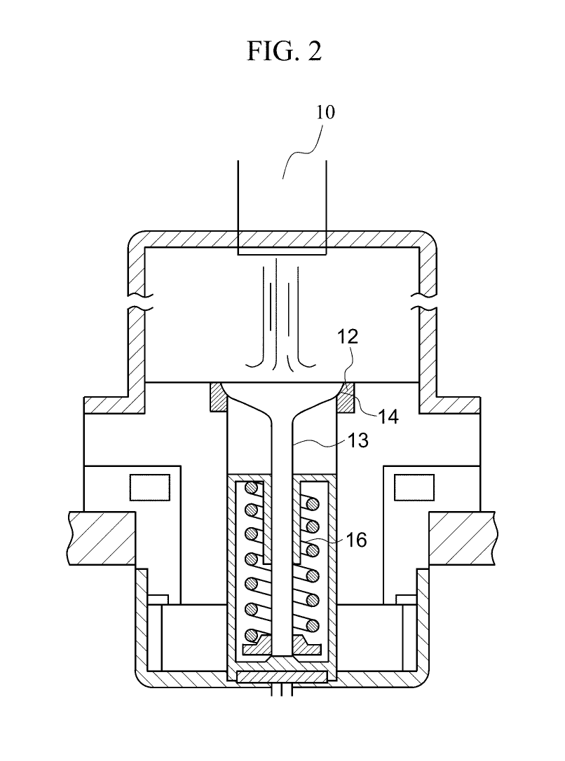

In this embodiment, a cladding alloy powder is melted, and then, a valve face portion (14) of an engine valve (13) adapted to contact a valve seat (12) is cladded with the melted cladding alloy powder (for example, see FIG. 2). Although the device shown in FIG. 2 is a wear tester described below, even in the actual engine valve, the positional relationship between the engine valve (13) and the valve seat (12) as well as the behavior of the valve is the same as described below.

In this embodiment, the engine valve (13) can be formed using cast iron, a steel material, or the like as a metal material. Preferably, austenitic heat-resisting steel (JIS standards: SUH35, SUH36, SUH660, NCF750, NCF751, and NCF800), martensitic heat-resisting steel (JIS standards: SUH1, SUH4, and SUH11), or the like can be used. Such a steel material is a steel material that contains nitrogen solid-dissolved therein to have increased heat resistance. The amount of nitrogen that is solid-dissolved in the steel material is preferably 0.01 to 0.60 mass %. However, nitrogen need not necessarily be solid-dissolved in the steel material. It should be noted that examples of the material of the valve seat (12) include Fe-based sintered alloys and Cu-based cladding alloys.

A cladding alloy powder with the aforementioned composition is used, and the cladding alloy powder is melted with a plasma cladding method or the like, and then, the surface of the valve face portion (14) of the engine valve (13) is cladded with the melted cladding powder. As the cladding alloy powder in this embodiment satisfies the aforementioned composition, a cladding alloy with high toughness that will hardly have cracks generated therein can be obtained as described above.

In addition, in this embodiment, the cladding alloy powder is made to contain 0.5 to 2.0 mass % Zr. Therefore, it is possible to increase the oxidation properties of Mo in a cladding alloy to be deposited, reduce generation of Mo-deficient phases along with generation of Mo carbides, and thus suppress a decrease in the corrosion resistance of the cladding alloy as described above. Consequently, wear resistance between the valve face portion (14) of the engine valve (13), which has the cladding alloy formed thereon, and the valve seat (12) adapted to contact the valve face portion (14) can be increased.

In addition, as the cladding alloy powder contains 0.5 to 2.0 mass % Zr, even when a steel material (engine valve 13) that contains nitrogen solid-dissolved therein is cladded with the cladding alloy powder, there will be a small number of blowholes generated in a cladding alloy to be deposited. In particular, a steel material that contains 0.01 to 0.60 mass % nitrogen is more effective in reducing the aforementioned generation of blowholes in the cladding alloy.

In comparison with when a gasoline fuel is used, when an alcohol fuel or a LPG (Liquid Petroleum Gas) or CNG (Compressed Natural Gas) natural fuel is used for the engine, a Mo oxide film is more difficult to be formed on a cladding alloy formed of the conventional cladding alloy powder, and thus, metal contact between the engine valve (13) and the valve seat (12) is likely to occur and adhesive wear of the valve seat (12) is thus likely to occur.

However, as in the present embodiment, a cladding alloy formed of the aforementioned cladding alloy powder containing Zr can easily have a Mo oxide film formed thereon. Therefore, metal contact between the engine valve (13) and the valve seat (12) can be reduced, and adhesive wear of the valve seat (12) can thus be suppressed.

Further, when an alcohol fuel or a natural gas fuel such as LPG or CNG is used, more acids are generated during combustion in comparison with when a gasoline fuel is used. Thus, the engine valve (13) is placed under an environment where it easily becomes corroded.

However, as a cladding alloy formed of the cladding alloy powder containing Zr in this embodiment has a reduced amount of Mo-deficient phases that are generated along with generation of Mo carbides, it is possible to suppress roughness of the surface of the cladding alloy formed on the engine valve (13) resulting from corrosion of the surface.

### EXAMPLES

Hereinafter, examples in accordance with the present disclosure will be described.

### Example 1

As a cladding alloy powder corresponding to an example of the present disclosure, a cladding alloy powder was produced that satisfies the conditions of containing 0.2 to 0.5 mass % C, 30 to 45 mass % Mo, 15 to 35 mass % Ni, 0.5 to 2.0 mass % Zr, and a balance including Co with unavoidable impurities.

Specifically, in Example 1, as shown in Table 1, a cladding alloy powder, which has been produced by melting a cladding alloy with a composition that satisfies the conditions of containing 0.3 mass % C, 40 mass % Mo, 20 mass % Ni, 1.0 mass % Zr, and a balance including Co with unavoidable impurities (an alloy containing Co as a base material) at a temperature of greater than or equal to 1700° C., and subjecting the melted alloy to gas atomizing using an inert gas, was classified into the range of 44 to 180 μm. Accordingly, a cladding alloy powder of Co-40Mo-20Ni-1.0Zr-0.3C was obtained.

Next, the cladding alloy powder was heated to a temperature of greater than or equal to 1700° C. using plasma welding under the conditions of an output of 100 A and a processing speed of 5 mm/sec so as to be melted, and then, the valve face portion 14 of the engine valve made of austenitic heat-resisting steel (JIS standard: SUH35) was cladded with the melted cladding alloy powder (see FIG. 2). Accordingly, a test piece of the engine valve 13 with the valve face portion 14 having a cladding alloy formed thereon was obtained.

### Examples 2 and 3: Zr Content

Test pieces were produced by depositing cladding alloy powders as in Example 1. It should be noted that each of Examples 2 and 3 is an example for specifying the upper limit and lower limit of the Zr content in the cladding alloy powder. Examples 2 and 3 differ from Example 1 in that as shown in Table 1, the cladding alloy powder of Example 2 contains 0.5 mass % Zr, and the cladding alloy powder of Example 3 contains 2.0 mass % Zr. Thus, the composition of the cladding alloy powder of Example 2 is Co-40Mo-20Ni-0.5Zr-0.3C, and the composition of the cladding alloy powder of Example 3 is Co-40Mo-20Ni-2.0Zr-0.3C.

### Examples 4 and 5: Mo Content

Test pieces were produced by depositing cladding alloy powders as in Example 1. It should be noted that each of Examples 4 and 5 is an example for specifying the upper limit and lower limit of the Mo content in the cladding alloy powder. Examples 4 and 5 differ from Example 1 in that as shown in Table 1, the cladding alloy powder of Example 4 contains 45 mass % Mo, and the cladding alloy powder of Example 5 contains 30 mass % Mo. Therefore, the composition of the cladding alloy powder of Example 4 is Co-45Mo-20Ni-1.0Zr-0.3C, and the composition of the cladding alloy powder of Example 5 is Co-30Mo-20Ni-1.0Zr-0.3C.

### Examples 6 and 7: Ni Content

Test pieces were produced by depositing cladding alloy powders as in Example 1. It should be noted that each of Examples 6 and 7 is an example for specifying the upper limit and lower limit of the Ni content in the cladding alloy powder. Examples 6 and 7 differ from Example 1 in that as shown in Table 1, the cladding alloy powder of Example 6 contains 35 mass % Ni, and the cladding alloy powder of Example 7 contains 15 mass % Ni. Therefore, the composition of the cladding alloy powder of Example 6 is Co-40Mo-35Ni-1.0Zr-0.3C, and the composition of the cladding alloy powder of Example 7 is Co-40Mo-15Ni-1.0Zr-0.3C.

### Examples 8 and 9: C Content

Test pieces were produced by depositing cladding alloy powders as in Example 1. It should be noted that each of Examples 8 and 9 is an example for specifying the upper limit and lower limit of the C content in the cladding alloy powder. Examples 8 and 9 differ from Example 1 in that as shown in Table 1, the cladding alloy powder of Example 8 contains 0.5 mass % C, and the cladding alloy powder of Example 9 contains 0.2 mass % C. Therefore, the composition of the cladding alloy powder of Example 8 is Co-40Mo-20Ni-1.0Zr-0.5C, and the composition of the cladding alloy powder of Example 9 is Co-40Mo-20Ni-1.0Zr-0.2C.

### Comparative Examples 1 and 2: Comparative Examples of the Zr Content

Test pieces were produced by depositing cladding alloy powders as in Example 1. It should be noted that each of Comparative Examples 1 and 2 is a comparative example of the Zr content of Examples 1 to 3. Comparative Examples 1 and 2 differ from Example 1 in that as shown in Table 1, the cladding alloy powder of Comparative Example 1 contains 3.0 mass % Zr, and the cladding alloy powder of Comparative Example 2 contains 0.0 mass % Zr (does not contain Zr). Therefore, the composition of the cladding alloy powder of Comparative Example 1 is Co-40Mo-20Ni-3.0Zr-0.3C, and the composition of the cladding alloy powder of Comparative Example 2 is Co-40Mo-20Ni-0.3C.

### Comparative Examples 3 and 4: Comparative Examples of the Mo Content

Test pieces were produced by depositing cladding alloy powders as in Example 1. It should be noted that each of Comparative Examples 3 and 4 is a comparative example of the Mo content of Examples 1, 4, and 5. Comparative Examples 3 and 4 differ from Example 1 in that as shown in Table 1, the cladding alloy powder of Comparative Example 3 contains 50 mass % Mo, and the cladding alloy powder of Comparative Example 4 contains 25 mass % Mo. Therefore, the composition of the cladding alloy powder of Comparative Example 3 is Co-50Mo-20Ni-1.0Zr-0.3C, and the composition of the cladding alloy powder of Comparative Example 4 is Co-25Mo-20Ni-1.0Zr-0.3C.

### Comparative Examples 5 and 6: Comparative Examples of the Ni Content

Test pieces were produced by depositing cladding alloy powders as in Example 1. It should be noted that each of Comparative Examples 5 and 6 is a comparative example of the Ni content of Examples 1, 6, and 7. Comparative Examples 5 and 6 differ from Example 1 in that as shown in Table 1, the cladding alloy powder of Comparative Example 5 contains 40 mass % Ni, and the cladding alloy powder of Comparative Example 6 contains 10 mass % Ni. Therefore, the composition of the cladding alloy powder of Comparative Example 5 is Co-40Mo-40Ni-1.0Zr-0.3C, and the composition of the cladding alloy powder of Comparative Example 6 is Co-40Mo-10Ni-1.0Zr-0.3C.

### Comparative Example 7: Comparative Example of the C Content

A test piece was produced by depositing a cladding alloy powder as in Example 1. It should be noted that Comparative Example 7 is a comparative example of the C content of Examples 1, 8, and 9. Comparative Example 7 differs from Example 1 in that as shown in Table 1, the cladding alloy powder of Comparative Example 7 contains 0.6 mass % C. Therefore, the composition of the cladding alloy powder of Comparative Example 7 is Co-40Mo-40Ni-1.0Zr-0.6C.

### Comparative Example 8: Comparative Example without Cladding

In Comparative Example 8, a test piece of an engine valve was produced by performing nitriding treatment on the base material used in Example 1 and without performing cladding with a cladding alloy powder.

TABLE 1

| | | | | | | | Oxidation | | |
|---|---|---|---|---|---|---|---|---|---|
| | | | | | | Generation | Start | Inner | Wear |
| | | | | | | Rate (%) of | Temperature | Hardness | Volume |
| | Mo | Ni | Zr | C | Co | Blowholes | (° C.) | (Hv) | Ratio |
| Example 1 | 40 | 20 | 1.0 | 0.3 | Balance | 2.4 | 456 | 650 | 0.20 |
| Example 2 | 40 | 20 | 0.5 | 0.3 | | 4.4 | 527 | 658 | 0.25 |
| Example 3 | 40 | 20 | 2.0 | 0.3 | | 0.0 | 440 | 638 | 0.19 |
| Example 4 | 45 | 20 | 1.0 | 0.3 | | 0.6 | 422 | 692 | 0.18 |
| Example 5 | 30 | 20 | 1.0 | 0.3 | | 3.0 | 583 | 597 | 0.28 |
| Example 6 | 40 | 35 | 1.0 | 0.3 | | 2.4 | 493 | 529 | 0.26 |
| Example 7 | 40 | 15 | 1.0 | 0.3 | | 2.5 | 444 | 683 | 0.21 |
| Example 8 | 40 | 20 | 1.0 | 0.5 | | 2.3 | 455 | 666 | 0.22 |
| Example 9 | 40 | 20 | 1.0 | 0.2 | | 2.0 | 460 | 641 | 0.22 |
| Comparative | 40 | 20 | 3.0 | 0.3 | | 0.0 | 550 | 622 | 0.26 |
| Example 1 | | | | | | | | | |
| Comparative | 40 | 20 | 0.0 | 0.3 | | 100.0 | 624 | 666 | 0.33 |
| Example 2 | | | | | | | | | |
| Comparative | 50 | 20 | 1.0 | 0.3 | | 0.0 | Cracks Generated | | |
| Example 3 | | | | | | | | | |
| Comparative | 25 | 20 | 1.0 | 0.3 | | 3.0 | 666 | 520 | 0.52 |
| Example 4 | | | | | | | | | |
| Comparative | 40 | 40 | 1.0 | 0.3 | | 2.2 | 508 | 424 | 0.88 |
| Example 5 | | | | | | | | | |

| | | | | | | |
|---|---|---|---|---|---|---|
| Comparative | 40 | 10 | 1.0 | 0.3 | 2.4 | Cracks Generated |
| Example 6 | | | | | | |
| Comparative | 40 | 20 | 1.0 | 0.6 | 2.4 | Cracks Generated |
| Example 7 | | | | | | |

| | | | | | |
|---|---|---|---|---|---|
| Comparative | Without Cladding | 0.0 | 890 | 427 | 1.00 |
| Example 8 | (SUH35 + Nitriding Treatment) | | | | |

<Tests for Measuring the Generation Rate of Blowholes>

A plurality of test pieces were produced by depositing the cladding alloy powders of Examples 1 to 9 and Comparative Examples 1 to 8, and cross-sections of the deposited cladding alloys were cut out. The cross-section of each cladding alloy was magnified by 100 times with an optical microscope to measure the generation rate of blowholes in the cladding alloy. Table 1 shows the results. It should be noted that the generation rate of blowholes was calculated from the number of cladding alloys having blowholes generated therein/the number of deposited cladding alloys.

<Tests for Measuring the Oxidation Start Temperature>

The cladding alloy powders of Examples 1 to 9 and Comparative Examples 1, 2, 4, and 5, and the base material of Comparative Example 8 were heated at a temperature increase rate of 10° C./minute in the air so as to be oxidized, and the temperature at which the weight increase due to oxidation became 0.3 weight % was measured as the oxidation start temperature. The results are shown in Table 1. Although the oxidation start temperature was measured using the cladding powder, the oxidation start temperature of a cladding alloy formed of such a cladding alloy powder shows approximately the same tendency. Cladding alloys formed of the cladding alloy powders of Comparative Examples 3, 6, and 7 had cracks generated therein. Therefore, tests for measuring the oxidation start temperature were not conducted thereon.

<Hardness Tests>

Cross-sections of test pieces of cladding alloys formed of the cladding alloy powders of Examples 1 to 9 and Comparative Examples 1, 2, 4, and 5 were cut out to measure the inner hardness of the cladding alloys using a hardness meter in accordance with JIS Z 2244. The surface hardness of the test piece formed through nitriding treatment of Comparative Example 8 was measured in a similar way. The results are shown in Table 1. It should be noted that the cladding alloys formed of the cladding alloy powders of Comparative Examples 3, 6, and 7 had cracks generated therein. Therefore, hardness tests were not conducted thereon.

<Observation of Structure>

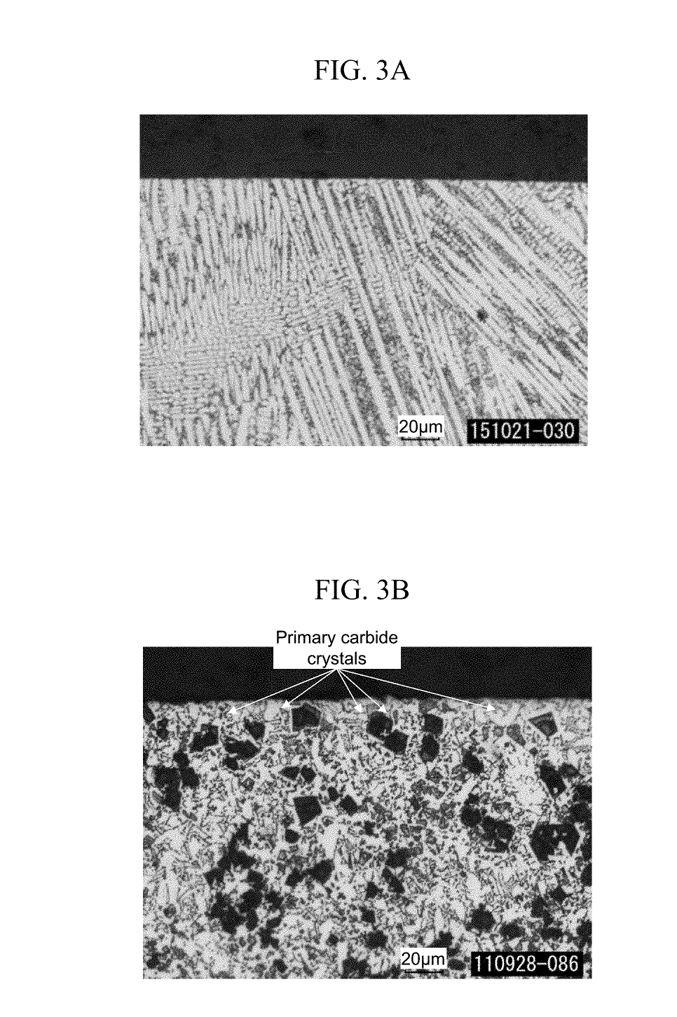

The structures of the cladding alloys of the test pieces of Example 1 and Comparative Example 6 were observed using an optical microscope. FIGS. 3A and 3B show the results.

<Wear Tests>

Using the wear tester shown in FIG. 2, the engine valve 13 (test piece) formed by depositing each of the cladding alloy powders of Examples 1 to 9 and Comparative Examples 1, 2, 4, and 5 was inspected regarding the agressivity against a counterpart member as well as the wear resistance of the cladding alloy portion. It should be noted that the engine valve formed through nitriding treatment of Comparative Example 8 was tested in a similar way. Specifically, a propane gas burner 10 was used as a heat source, and a sliding portion between the valve face portion 14 cladded as described above and the valve seat 12 made of a Fe-based sintered material was placed in a propane gas burning atmosphere.

The temperature of the valve seat 12 was controlled to 250° C. that is close to the temperature of the actual engine valve, and a load of 25 kgf was applied with a spring 16 when the valve face 14 contacted the valve seat 12, and contact was made to occur at a rate of 3250 times/minute to conduct a 8-hour wear test. In the wear test, the amount of sinking of the valve from the reference position was measured. The amount of sinking of the valve corresponds to the volume of wear (depth of wear) of each of the engine valve 13 and the valve seat 12 upon contact therebetween. The results are shown in Table 1. It should be noted that Table 1 shows the wear volume ratio of each example with reference to the wear volume of Comparative Example 8 as 1.00. Meanwhile, as the cladding alloys formed of the cladding alloy powders of Comparative Examples 3, 6, and 7 had cracks generated therein, wear tests were not conducted thereon.

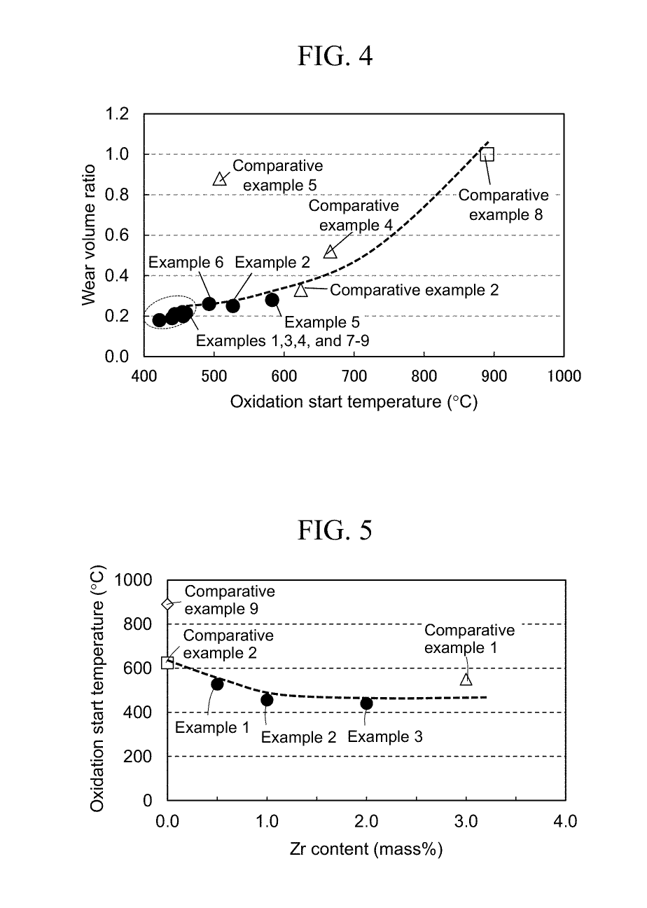

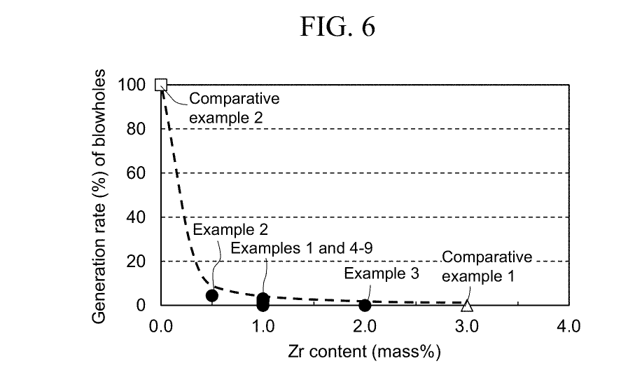

Further, FIG. 4 shows the relationship between the oxidation start temperature and the wear volume ratio of each of Examples 1 to 9 and Comparative Examples 2, 4, 5, and 8. FIG. 5 shows the relationship between the Zr content and the oxidation start temperature of each of Examples 1 to 3 and Comparative Examples 1, 2, and 9. FIG. 6 shows the relationship between the Zr content and the generation rate of blowholes of each of Examples 1 to 9 and Comparative Examples 1 and 2.

<Corrosion Tests>

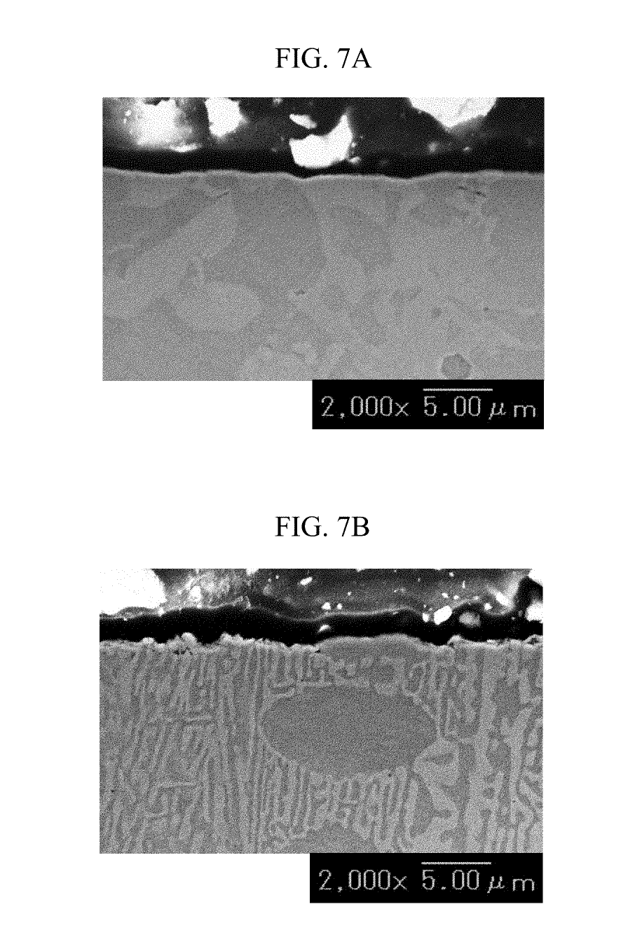

Test pieces formed by depositing the cladding alloy powders of Example 1 and Comparative Example 2 were immersed in an acid solution with a pH of 3.5 for 24 hours, and then the surfaces of the test pieces were observed. Cross-sections of the test pieces of Example 1 and Comparative Example 2 were cut out to observe the cladding alloys with a scanning electron microscope (SEM). FIG. 7A and FIG. 7B show the results.

[Results: Relationship Between the Oxidation Start Temperature and Wear Volume Ratio]

As shown in FIG. 4 and Table 1, it is found that the wear volume ratios of Examples 1 to 9 are smaller than those of Comparative Examples 2, 4, 5, and 8. As is also obvious from FIG. 4, the lower the oxidation start temperature, the lower the wear volume ratio, and when the oxidation start temperature is less than or equal to 600° C., the wear volume ratio is less than or equal to 0.25. In addition, each of the engine valves of Comparative Examples 2, 4, and 8 was confirmed to have adhesive wear on its surface after the test. Accordingly, it is considered that Examples 1 to 9 have improved wear resistance than those of Comparative Examples 2, 4, and 8 as Mo oxide films were formed on the surfaces of the cladding alloys (engine valves) of Examples 1 to 9 whose oxidation start temperatures were lower than those of Comparative Examples 2, 4, and 8.

(Optimal Mo Content)

Herein, the oxidation start temperature of Comparative Example 4 is higher than those of Examples 1 to 9. This is considered to be due to the reason that as shown in Table 1, the Mo content of Comparative Example 4 is less than 30 mass % (25 mass %), and with such too small content of Mo, an Mo oxide film was difficult to form. Accordingly, it is considered that adhesive wear of the cladding alloy of Example 4 was promoted.

Meanwhile, Comparative Example 3 has a Mo content of over 45 mass % (50 mass %). Therefore, it is considered that Mo carbides were easily formed in the cladding alloy, which in turn decreased the toughness of the cladding alloy, and thus, cracks were generated in the cladding alloy as shown in Table 1. Therefore, from Examples 1, 4, and 5, the optimal Mo content in the cladding alloy powder is considered to be 30 to 45 mass %.

(Optimal Ni Content)

As shown in FIG. 4, the wear volume ratio of Comparative Example 5 is higher than those of Examples 1 to 9 although the oxidation start temperature is low. This is because as shown in Table 1, as the Ni content of Comparative Example 5 is over 35 mass % (40 mass %), the inner hardness of the cladding alloy is lower than those of Examples 1 to 9.

Meanwhile, in Comparative Example 6, cracks were generated in the cladding alloy as shown in Table 1. This is considered to be due to the reason that as Comparative Example 6 has a Ni content of less than 15 mass % (10 mass %), the limit of the amount of C that can be solid-dissolved in the Co base material decreased, and primary carbide crystals of MoC were thus generated in the deposited cladding alloy, which in turn decreased the toughness of the cladding alloy as shown in FIG. 3B. Meanwhile, as shown in FIG. 3A, in Example 1, eutectic carbides (black portion in FIG. 3A) were formed in the cladding alloy between Mo and the Co base material having Ni solid-dissolved therein (white portion in FIG. 3A). Therefore, from Examples 1, 6, and 7, the optimal Ni content in the cladding alloy powder is considered to be 15 to 35 mass %.

(Optimal C Content)

In Comparative Example 7, cracks were generated in the cladding alloy as shown in Table 1. This is considered to be due to the reason that as Comparative Example 7 has a C content of over 0.5 mass % (0.6 mass %), primary carbide crystals of MoC were generated in the cladding alloy, which in turn decreased the toughness of the cladding alloy.

Meanwhile, it is obvious that C can improve the wear resistance when combined with Mo to become a carbide, and if the C content is 0.2 mass % as in Example 9, the wear volume ratio is 0.22, and the wear resistance is thus ensured. Therefore, from Examples 1, 8, and 9, the optimal C content in the cladding alloy powder is found to be 0.2 to 0.5 mass %.

(Optimal Zr Content)

As shown in FIG. 5, the oxidation start temperature of each of Examples 1 to 3 is lower than that of Comparative Example 2, and is lower as the Zr content is higher. However, even if the Zr content is over 2.0 mass % as in Comparative Example 1, a further decrease in the oxidation start temperature cannot be expected. Accordingly, it is considered that the optimal Zr content in the cladding alloy powder is 0.5 to 2.0 mass % in order to form an oxide film with Mo and thus increase the wear resistance.

Herein, as shown in FIG. 7B, in Comparative Example 2 after the corrosion test, irregularities were formed on the surface of the cladding alloy with Mo carbides protruding from the surface, and thus, the surface of the cladding alloy became rougher than that before the corrosion test. This is considered to be due to the reason that the Co base material has become corroded due to galvanic corrosion between the Mo carbides and the Co base material with a small amount of Mo (Mo-deficient phase) around the Mo carbides, as described above with reference to FIG. 1.

Meanwhile, as shown in FIG. 7A, the surface of the cladding alloy of Example 1 after the corrosion test is found to be smoother than that of Comparative Example 2. This is considered to be due to the reason that as the cladding alloy powder of Example 1 contains Zr, carbides were preferentially generated with Zr than with Mo during cladding. Accordingly, Mo to be consumed as Mo carbides during cladding can be allowed to remain in the state of being solid-dissolved in the Co base material. Consequently, it is possible to suppress generation of Mo-deficient phases and thus suppress galvanic corrosion resulting from Mo-deficient phases in comparison with Comparative Example 2.

Further, as each of Examples 1 to 9 contains Zr, Zr is carbonized preferentially than is Mo as described above. Consequently, the amount of Mo that is solid-dissolved in the Co base material is increased than that in Comparative Example 2 without Zr. Therefore, a Mo oxide film is easily formed with Mo in the Co base material. Consequently, the oxidation start temperature of each of Examples 1 to 9 is considered to be lower than that of Comparative Example 2.

Accordingly, as hard Mo carbides protrude in Comparative Examples 2 as opposed to each of the surfaces of valve face portions having the cladding alloys of Examples 1 to 9 formed thereon, agressivity against a counterpart member, specifically, a valve seat that slides on the engine valve is increased. Further, as the oxidation start temperature of Comparative Example 2 is high, a Mo oxide film is difficult to be formed on the surface of the cladding alloy. Consequently, as shown in Table 1, the wear volume ratio of Comparative Example 2 is considered to be higher than those of Comparative Examples 1 to 9.

As shown in FIG. 6, the generation rate of blowholes in the cladding alloy of Comparative Example 2 is 100%. This is considered to be due to the reason that nitrogen solid-dissolved in the base material (steel material) to be cladded was released during cladding, and was generated as a nitrogen gas, which was then contained in the cladding alloy in the molten state.

Meanwhile, as each of Examples 1 to 9 contains Zr, it is considered that Zr that is solid-dissolved in the Co base material is combined with N, thus not generating a nitrogen gas. Consequently, it is considered that the cladding alloys of Examples 1 to 9 are difficult to have blowholes formed therein in comparison with Comparative Example 2. However, even when greater than or equal to 2.0 mass % (3.0 mass %) Zr is contained as in Comparative Example 1, advantageous effects more than those described above cannot be expected.

Although the embodiments of the present disclosure have been described in detail above, the present disclosure is not limited thereto, and a variety of design changes is possible within the spirit and scope of the present disclosure recited in the claims.

### DESCRIPTION OF SYMBOLS

12 Valve seat
13 Engine valve
14 Valve face portion

What is claimed is:

1. A cladding alloy powder comprising:
0.2 to 0.5 mass % C;
30 to 45 mass % Mo;
15 to 35 mass % Ni;
0.5 to 2.0 mass % Zr; and
a balance including Co with unavoidable impurities.

2. A method for producing an engine valve, comprising:
melting the cladding alloy powder recited in claim 1; and
cladding a valve face portion of an engine valve adapted to contact a valve seat with the melted cladding alloy powder.

3. The method for producing an engine valve according to claim 2, wherein the engine valve is adapted to be used for an engine in which an alcohol fuel, Liquefied Petroleum Gas or Compressed Natural Gas is used as a fuel.
